(19) United States
(12) Patent Application Publication
(10) Pub. No.: US 2026/0305520 A1
(43) Pub. Date: Oct. 8, 2026

(54) DISTRIBUTION ASSEMBLY FOR A SEED DRILL WITH AN ASSOCIATED CLEARANCE ADJUSTMENT DEVICE AND ASSOCIATED SEED DRILL

(71) Applicant: KUHN SAS, Saverne (FR)

(72) Inventors: Olivier CONSTANT, Weiterswiller (FR); Louis MATHIS, Strasbourg (FR)

(73) Assignee: KUHN SAS, Saverne (FR)

(21) Appl. No.: 19/576,308

(22) Filed: Mar. 24, 2026

(30) Foreign Application Priority Data
Apr. 2, 2025 (FR) FR2503454

(51) Int. Cl. A01C 7/04

(52) U.S. Cl. CPC A01C 7/046; A01C 7/0445

(57) ABSTRACT

A distribution assembly includes a housing including a fixed part and a door, a disk disposed inside the housing to separate the interior of the housing into a first chamber and a second chamber including an intermediate partition, and a device for adjusting a clearance between the second surface of the disk and the fixed part. The clearance adjustment device is configured to allow translational movement, in an axial direction parallel to the drive shaft, of the intermediate partition-disk subassembly relative to the fixed part and to constrain the position of the intermediate partition-disk subassembly relative to the fixed part. The adjustment device includes an adjustment member for the clearance protruding from the outer face of the door.

### BACKGROUND OF THE INVENTION

### Field of the Invention

The invention relates to the field of distribution assemblies for a seed drill including a clearance adjustment device and to the field of seed drills.

### Description of the Related Art

In a precision seed drill, a distribution assembly generally includes a sealed housing in two parts, a fixed part and a door, which includes a perforated disk driven by a motor. The disk separates the housing into two areas in which the air pressures are different, thus creating a pressure difference, which may be positive or negative, on either side of the disk. The housing is connected to a blower that manages the pressure difference according to the type of seed, the forward speed, etc. At the bottom of the disk, i.e. at the bottom of the housing, there is a seed reservoir, supplied by a hopper. These seeds are in contact with the rotating disk, which, as it rotates, will draw the seeds one by one into its perforations.

The diameter and shape of the holes in the disk are designed to accommodate a seed, which is held in place by the difference in pressure between the two sides of the disk. The holes are often surrounded by special raised and/or recessed shapes in the disc that guide and/or direct the seeds toward the perforation. These areas around the holes are called agitators.

Once the seeds are in the holes in the disk, a selection system removes any excess seeds to prevent double sowing, as several seeds may sometimes end up in a single hole. Selection can be carried out using teeth, brushes, etc., which are fixed to the outside and/or inside of the seed path. The excess seeds fall back into the reserve.

Once the seeds have been selected, they are transported to the final distribution area, which is generally located in the last quarter turn of the disk, where there is no longer any pressure difference. This causes the seed to exit the hole and be distributed onto the ground. The ejection of the seed can be assisted by a roller that cuts the pressure difference and possibly pushes the seed out of the hole using spikes.

There is also clearance between the disk and the fixed part of the housing.

It should preferably be possible to adjust the clearance between the disk and the fixed part of the housing. This clearance must be correctly adjusted to prevent contact between the disk and the fixed part of the housing, while avoiding creating a gap that would allow seeds to pass through. Incorrectly adjusted clearance increases the power requirement due to unnecessary friction.

Document EP3726954B1 already discloses that the distance between the perforated disk and the stationary part of the housing can be adjusted. However, in the proposed solution, the clearance can only be adjusted when the door is open by adjusting a threaded rod with a screw thread on the disk and the drive shaft. Consequently, manipulation is not simple, which does not allow for optimal adjustment of the clearance.

### SUMMARY OF THE INVENTION

The present invention aims to overcome at least one of these drawbacks and to provide an alternative solution for adjusting the clearance, allowing for optimal adjustment with simple handling.

To this end, the invention relates to a distribution assembly for a seed drill including at least:
a sealed housing including at least one fixed part and a door that can be moved between an open position and a closed position,
a drive shaft of a motor opening onto the fixed part,
a distribution member for a plurality of granular elements arranged to distribute a plurality of granular elements in a discrete and singular manner in the form of a perforated disk having a first surface facing the interior of the door in the closed position and a second surface facing the fixed part in the closed position, the disk being mounted around the motor drive shaft to be driven in rotation at least in the closed position and being disposed inside the housing to separate the interior of the housing into a first chamber and a second chamber, which are distinct, the first chamber being configured to receive all or part of the plurality of granular elements and the second chamber being closed by the door,
the second chamber includes a bell-shaped intermediate partition including a circular bearing surface bearing on a peripheral edge of the first surface of the disk,
a device for adjusting a clearance corresponding to the distance between the second surface of the disk and the fixed part of the housing in the closed position,

distribution assembly characterized in that:
the clearance adjustment device is configured to allow translational movement, in an axial direction parallel to the drive shaft, of the intermediate partition-disk subassembly relative to the fixed part of the housing and to constrain the position of the intermediate partition-disk subassembly relative to the fixed part,
the adjustment device includes an adjustment member for the clearance protruding from the outer face of the door, and configured to adjust the clearance.

The invention also relates to a seed drill including a distribution assembly, characterized in that the distribution assembly is in accordance with the invention.

### BRIEF DESCRIPTION OF THE DRAWINGS

The invention will be better understood from the following description, which relates to several preferred embodiments, given as non-limiting examples, and explained with reference to the accompanying schematic drawings, in which:

FIG. 1 shows a perspective view of the distribution assembly according to the invention,

FIG. 2 shows a front view of the distribution assembly according to the invention of FIG. 1,

FIG. 3 shows a cross-sectional view of the distribution assembly according to the invention of FIG. 1,

FIG. 4 shows a detail of FIG. 3 showing the location of the clearance,

FIG. 5 shows a perspective view of the door showing the adjustment member of the adjustment device of the distribution assembly according to the invention,

FIG. 6 shows a detailed view of FIG. 3 showing the adjustment member of the distribution assembly according to the invention,

FIG. 7 shows a cross-sectional view of the door and the intermediate partition-disk subassembly of the distribution assembly according to the invention,

FIG. 8 shows a perspective view from below of the door and the intermediate partition-disk subassembly of the distribution assembly according to the invention,

FIG. 9 shows a perspective view of the adjustment device and the intermediate partition-disk subassembly of the distribution assembly according to the invention,

FIG. 10 shows a cross-sectional view of the adjustment device and the disk of the distribution assembly according to the invention,

FIG. 11 shows a perspective view of the adjustment device, the disk and the ejection device of the distribution assembly according to the invention, and

FIG. 12 shows a perspective view of the adjustment device and the ejection device of the distribution assembly according to the invention.

### DETAILED DESCRIPTION OF THE PREFERRED EMBODIMENTS

A distribution assembly for a seed drill includes at least:
a sealed housing 1 including at least one fixed part 2 and a door 3 that can be moved between an open position and a closed position POFF,
a drive shaft 4 of a motor 5 opening onto the fixed part 2,
a distribution organ 6 of a plurality of granular elements arranged to distribute a plurality of granular elements discretely and individually in the form of a perforated disk 7 having a first surface 8 facing the inside of the door 3 in the closed position POFF and a second surface 9 facing the fixed part 2 in the closed position POFF, wherein at least in the closed position POFF, the disk 7 is mounted around the drive shaft 4 of the motor 5 to be driven in rotation and being disposed inside the housing 1 to separate the interior of the housing 1 into a first chamber 10 and a second chamber 11, which are distinct, wherein the first chamber 10 is configured to receive all or part of the plurality of granular elements and the second chamber 11 is closed by the door 3,
the second chamber 11 includes a bell-shaped intermediate partition 12 including a circular bearing surface 13 bearing on a peripheral edge 14 of the first surface 8 of the disk 7,
an adjustment device 15 for a clearance J corresponding to the distance between the second surface 9 of the disk 7 and the fixed part 2 of the housing 1 in the closed position POFF.

According to the invention, the distribution assembly is characterized in that:
the adjustment device 15 of the clearance J is configured to allow translational movement, in an axial direction parallel to the drive shaft 4, of the intermediate partition 12—disk 7 subassembly relative to the fixed part 2 of the housing 1 and to constrain the position of the intermediate partition 12—disk 7 subassembly relative to the fixed part 2,
the adjustment device 15 includes an adjustment member 17 for the clearance J protruding from the outer face 3a of the door 3, and configured to adjust the clearance J.

Advantageously, this solution has the advantage of allowing the clearance J to be adjusted from outside the door 3 even when the door 3 is in the closed position POFF. The clearance J is adjusted by shifting the bell-shaped intermediate partition 12 and the disk 7 relative to the fixed part 2 of the housing 1 and by constraining the bell-shaped intermediate partition 12—disk 7 subassembly in the desired position so as to lock the adjustment of the clearance J. This results in simple handling that allows for optimal adjustment of the clearance J and reduced drive power requirements due to the absence of friction.

Preferably, the adjustment device 15 includes a spring member 18 located inside the second chamber 11 between the inner face 3b of the door 3 and the upper outer surface 16 of the intermediate partition 12.

Advantageously, the spring member 18 allows the bell-shaped intermediate partition-disk 7 subassembly to be constrained in the desired position. This results in a stable adjustment of the clearance J.

Preferably, the door 3 includes a central passage 19 and the adjustment device 15 includes a sleeve 20 passing through the central passage 19, mounted so as to slide in the direction of axial translation in the central passage 19 and including an internal portion 21 located in the second chamber 11 including a bearing 22 around which the intermediate partition 12 is mounted integrally, and in that the inner face 3b of the door 3 bears against the spring member 18 and the spring member 18 bears against the bearing 22 so as to exert a bearing force to constrain the intermediate partition 12—disk 7 subassembly.

Advantageously, this configuration allows the intermediate partition 12—disk 7 subassembly to be offset relative to the door 3 and the fixed part 2 in order to adjust the clearance J. Furthermore, the adjustment device 15 is provided around the central passage 19, which is configured for atmospheric pressure. The intermediate partition 12—disk 7 assembly is mounted so that it can rotate relative to the sleeve 20 via the bearing 22, which allows the disk 7 and the intermediate partition 12 to be driven together by the motor 5. The bearing force is applied to the bearing 22, which prevents wear on the spring member 18.

Preferably, the sleeve 20 includes a protruding outer end 23 of the outer face 3a of the door 3, the protruding outer end 23 including an outer wall 24 with a thread 25, and the adjustment member 17 includes an adjustment nut 26 associated with the thread 25.

This arrangement allows the clearance J to be adjusted from outside the door 3 by simply tightening or loosening the adjustment nut 26.

Preferably, the spring member 18 includes at least one spring washer 27 positioned around the inner portion 21 of the sleeve 20 and bearing on the bearing 22.

This example is not exhaustive, and the spring washer 27 can be replaced by another type of spring that performs the same function.

Preferably, the sleeve 20 includes an inner end 28 located in the space 29 between the intermediate partition 12 and the disk 7, and the distribution assembly includes an ejection device 30 fixed to or near the inner end 28.

This arrangement allows the presence of the sleeve 20 to be used to position the ejection device 30 in the second chamber 11. The ejection device 30 allows the pressure difference to be eliminated and, if necessary, to push a granular element, such as a seed, located in a perforation 35 in the disk 7 out of the latter.

Preferably, the distribution assembly includes a cover 31 covering the adjustment member 17, and the cover 31 is secured by at least one fastener 32 to the door 3.

The cover 31 located above the adjustment member 17 also serves to lock the position of the latter to prevent it from coming out of adjustment, for example during operation.

Preferably, the outer face 3a of the door 3 includes a visual indicator 33 representing the adjustment of the clearance J arranged around the adjustment member 17.

This feature makes it easier to identify the adjustment of the clearance J by providing a visual indication to the user. For example, it is possible to identify the factory setting in the event of disassembly for maintenance or repair.

Preferably, the intermediate partition 12 and the disk 7 are secured together by assembly components 34.

Thus, the disk 7 is held and locked in position on the intermediate partition 12.

Other advantages of the present invention are set out below. The adjustment of the clearance J is preferably carried out at the factory so that the distribution assembly is correctly adjusted for the end user. When assembling the distribution system, the operator brings the disk 7 into contact with the fixed part 2 of the housing 1, which corresponds to an extreme setting, then tightens the adjustment member 17 by a certain number of turns to obtain a certain clearance J distance.

Except in extreme cases, such as wear and tear on the housing 1, the end user no longer needs to adjust this clearance J. If the user changes disk 7 for a replacement or to sow another type of seed, the clearance J does not need to be readjusted because all disks 7 are the same thickness.

The housing 1 includes the fixed part 2 and the door 3, which is movable relative to the fixed part 2 and allows the housing 1 to be opened to provide access to the interior of the housing 1 or to be closed.

The door 3 thus adopts either an open position or a closed position POFF. In the open position, the door 3 can, if necessary, be completely removed from the fixed part 2 or be connected to it while providing access to the interior of the housing 1. The door 3 is preferably cylindrical in shape. The door 3 includes the central passage 19, which allows air to be exchanged between the outside and inside of the housing 1. This air exchange is guided by the cover 31.

The distribution member 6 includes the perforated distribution disk 7 driven in rotation by the motor 5 around the drive shaft 4. The distribution disk 7 separates the housing 1 into two chambers, the first chamber 10 and the second chamber 11, in which the air pressures are preferably different. The first chamber 10 and the second chamber 11 preferably have a substantially cylindrical shape. The door 3 receives the distribution disk 7. The distribution disk 7 preferably includes a plurality of perforations 35.

The intermediate partition 12 and the disk 7 are preferably secured together. The intermediate partition 12 is also driven in rotation around the drive shaft 4 via the movement of the disk 7.

The adjustment device 15 serves to allow the bell-shaped intermediate partition 12 and the disk 7 to be shifted transversely relative to the fixed part 2 of the housing 1 and to hold the bell-shaped intermediate partition 12—disk 7 subassembly in the desired position, so as to adjust and then lock the adjustment of the clearance J.

The adjustment device 15 also allows the clearance J to be adjusted from outside the door 3 via the adjustment member 17.

In the example shown, the adjustment device 15 includes the adjustment member 17, the sleeve 20, and the spring member 18.

The adjustment member 17 of the clearance J protrudes from the outer face 3a of the door 3. It is thus accessible from outside the housing 1. Preferably, the adjustment member 17 includes the adjustment nut 26.

The spring member 18 serves to constrain the position of the intermediate partition 12—disk 7 subassembly in order to lock the setting of the clearance J.

The spring member 18 is preferably a spring washer 27 or equivalent.

The sleeve 20 is preferably generally cylindrical in shape.

The sleeve 20 preferably includes the inner portion 21 surrounded by the protruding outer end 23 and the inner end 28 which is opposite the protruding outer end 23.

The intermediate partition 12 is preferably crossed by the sleeve 20 at an opening 12a aligned with the central passage 19.

The bearing 22 is mounted integrally in the opening of the intermediate partition 12 and on the inner portion 21 of the sleeve 20.

The bearing 22 allows the intermediate partition 12 to be secured to the sleeve 20 at the inner portion 21 while allowing it to rotate around the drive shaft 4.

The protruding outer end 23 protrudes from the outer face 3a of the door 3. Its outer wall 24 has a thread 25 onto which the adjustment nut 26 is screwed, which can be tightened or loosened depending on the direction of rotation applied. The number of turns applied to the adjustment nut 26 allows the clearance J to be adjusted.

The inner end 28 of the sleeve 20 and the ejection device 30 are preferably located in the space 29.

The inner end 28 of the sleeve 20 may have a flared shape, preferably conical.

The inner end 28 of the sleeve 20 is preferably opposite the upper surface 8 of the disk 7.

The ejection device 30 serves to eliminate the pressure difference and, if necessary, push a granular element, such as a seed, located in a perforation 35 in the disk 7 out of the latter.

The ejection device 30 preferably includes a separation wheel 36 having a rotation axis 37.

The separation wheel 36 has a plurality of radial projections 39 protruding from the peripheral surface 38, each of the radial projections 39 being configured to fit into one of the perforations 35 in an insertion position.

Preferably, the radial projections 9 are configured to fit through the entrance 40 of one of the perforations 35 in a sealed manner inside the latter by a form fit and/or by a sealing element in the insertion position so as to achieve sealing inside the perforation 35.

The separation wheel 36 is preferably mounted to rotate around the rotation axis 37 on a support 41 that is fixed to the inner end 28.

Each radial projection 39 in the form of a circular cylinder with a curved profile or truncated cone has a preferably flat or domed apex 42 from which a centering pin 43 protrudes. The centering pin 43 is configured to extend toward the exit of the perforation 35 in the insertion position.

The cover 31 covers the adjustment device 17, but preferably also the central passage 19. The cover 31 can preferably be removed from the door 3 by removing the fasteners 32. The fasteners 32 may include screws or similar.

The visual indicator 33 may include a scale with a set of lines 44 and a measurement value 45, indicating the adjustment of the clearance J between two adjacent lines 44. In the example shown, the measurement value 45 is 0.1 millimeters. The lines 44 are preferably spaced at regular intervals in a circle around the adjustment nut 26 on the outer face 3a of the door 3. The visual indicator 33 is visible from outside the door 3 at least when the cover 31 is not fitted. In a non-illustrated variant, the visual indicator 33 may also include a measurement representing a clearance setting value recommended by the manufacturer, or a clearance setting value corresponding to the setting made by the manufacturer when the distribution assembly was assembled at the factory.

The assembly components 34 enable the disk 7 to be attached to the intermediate partition 12 in a removable manner. The connection is designed to allow rotation, for example, of one-eighth of a turn. The intermediate partition 12 includes several protrusions onto which recesses provided on the outer periphery of the disk 7 are placed. These protrusions have a sloping profile, and the rotation of the disk 7 on the intermediate partition 12 allows the connection to be tightened and thus the disk 7 to be secured to the intermediate partition 12.

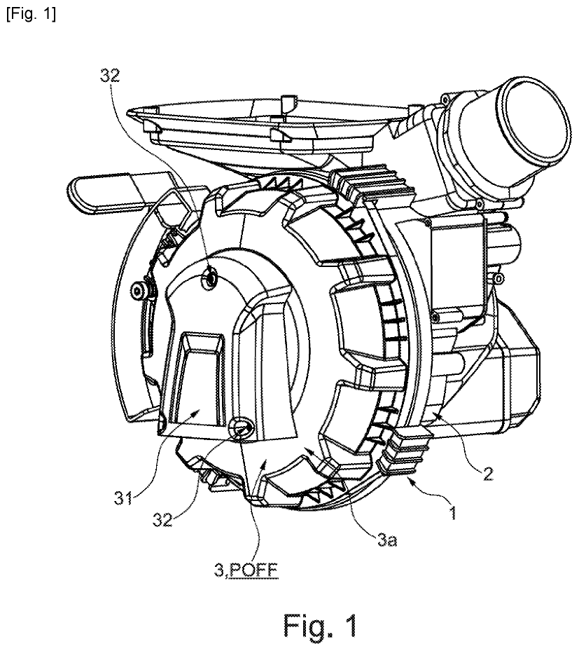

FIGS. 1 to 3 show the distribution assembly according to the invention.

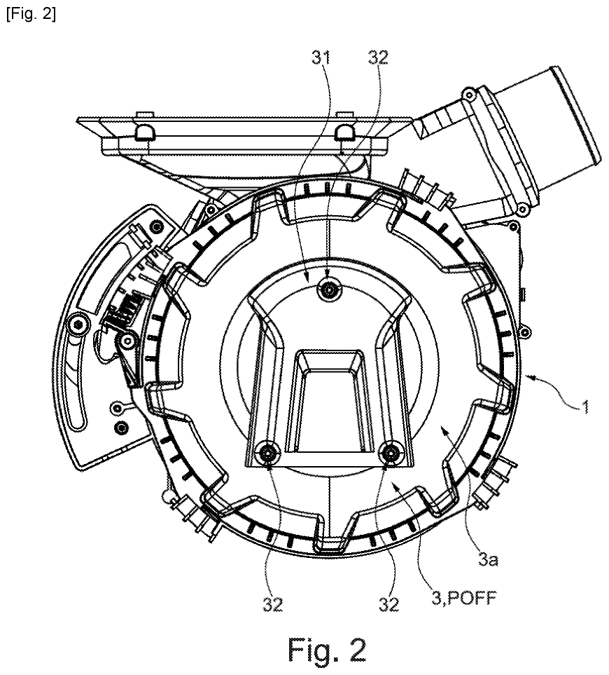

FIGS. 1 and 2 show the sealed housing 1 with the door 3 covering and sealing the fixed part 2 in the closed position POFF. The door 3 is equipped with the cover 31, which is mounted by the fasteners 32 on the outer face 3a of the door 3.

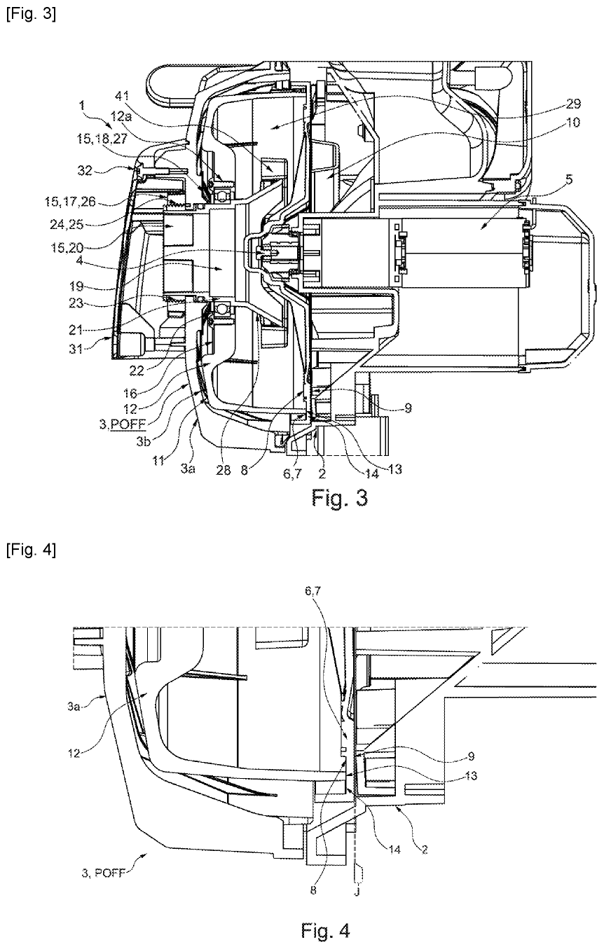

FIG. 3 also shows that the distribution assembly includes the motor 5 with its drive shaft 4 extending into the fixed part 2. The disk 7 is located inside the housing 1 and is mounted around the drive shaft 4. The disk 7 separates the interior of the housing 1 into two compartments, with the first chamber 10 on the side of the fixed part 2 and the second chamber 11 on the side of the door 3. In the second chamber 11 is also located the bell-shaped intermediate partition 12 with its circular bearing surface 13 bearing on the peripheral edge 14 of the first surface 8 of the disk 7 and which is integral with the disk 7. The adjustment device 15 for the clearance J includes the adjustment member 17, the sleeve 20, and the spring member 18. The adjustment member 17 is in the form of an adjustment nut 26 which is screwed onto the thread 25 of the outer wall 24 of the protruding outer end 23 of the sleeve 20 and which protrudes from the outer face 3a of the door 3. The sleeve 20 passes through the central passage 19 and is mounted so that it can slide in the axial direction within the latter. The sleeve 20 passes through the intermediate partition 12 at the opening 12a. The bearing 22 is mounted integrally in the opening 12a of the intermediate partition 12 and on the inner portion 21 of the sleeve 20. The spring member 18 is in the form of a spring washer 27 which is arranged around the inner portion 21 and bears against the bearing 22 and the inner face 3b of the door 3. The adjustment member 17 is covered by the cover 31, which is secured to the door 3 by fasteners 32 in the form of screws. The inner end 28 of the sleeve 20, which is opposite the protruding outer end 23, is located in the space 29, as is the support 41 for the separation wheel 36 (not visible), which is attached to the inner end 28. The inner end 28 of the sleeve 20 has a conical flared shape. The inner end 28 of the sleeve 20 faces the upper surface 8 of the disk 7.

FIG. 4 illustrates the location of the clearance J, which corresponds to the gap between the second surface 9 of the disk 7 and the fixed part 2 of the housing 1 in the closed position POFF of the door 3.

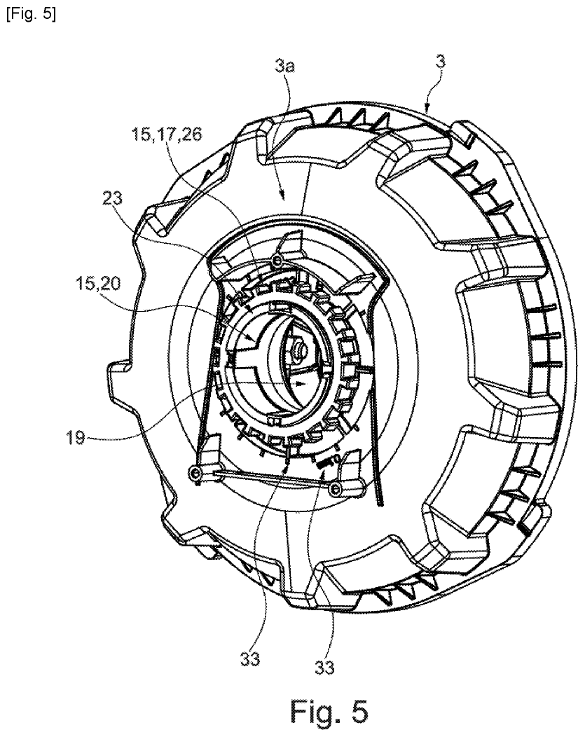

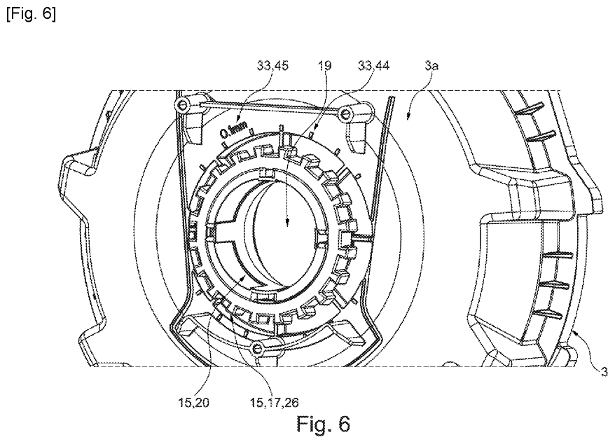

FIGS. 5 and 6 illustrate the door 3 with the adjustment member 17 of the adjustment device 15 without the cover 31, which has been removed, and with the visual indicator 33 visible from outside the door 3, since the cover 31 is not fitted. The adjustment member 17 in the form of the adjustment nut 26 is screwed onto the protruding outer end 23 of the outer face 3a of the door 3. The visual indicator 33 takes the form of a scale with a set of lines 44 and a measurement value 45, indicating the adjustment increment J between two adjacent lines 44. This measurement value 45 is 0.1 millimeters. The lines 44 are spaced at regular intervals in a circle, at least in part, around the central passage 19 and the adjustment nut 26 on the outer face 3a of the door 3.

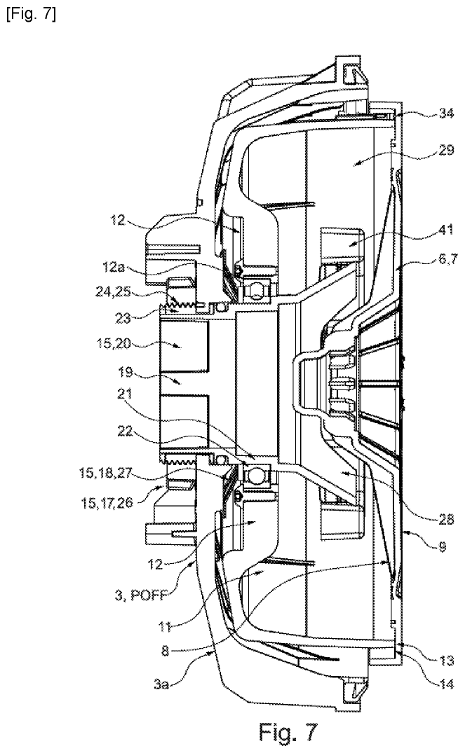

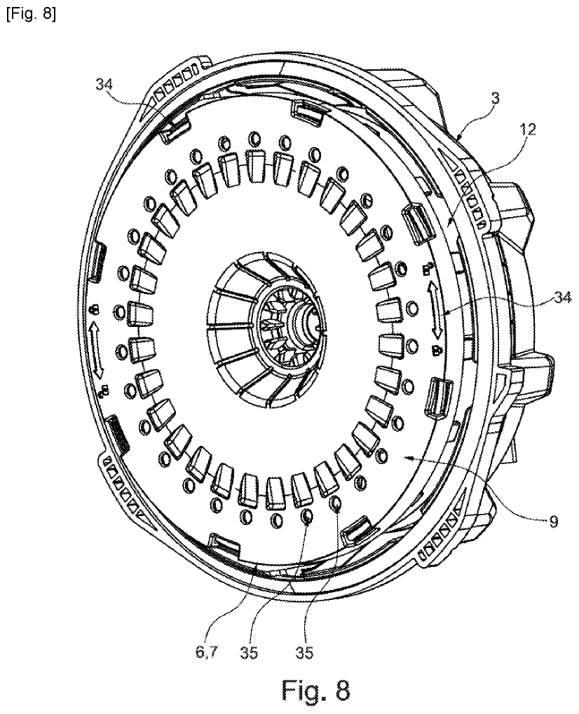

FIGS. 7 and 8 show door 3 with the previously described intermediate partition 12—disk 7 subassembly without the cover 31. The disk 7 and intermediate partition 12 are secured to each other by the assembly components 34. The disk 7 includes perforations 35.

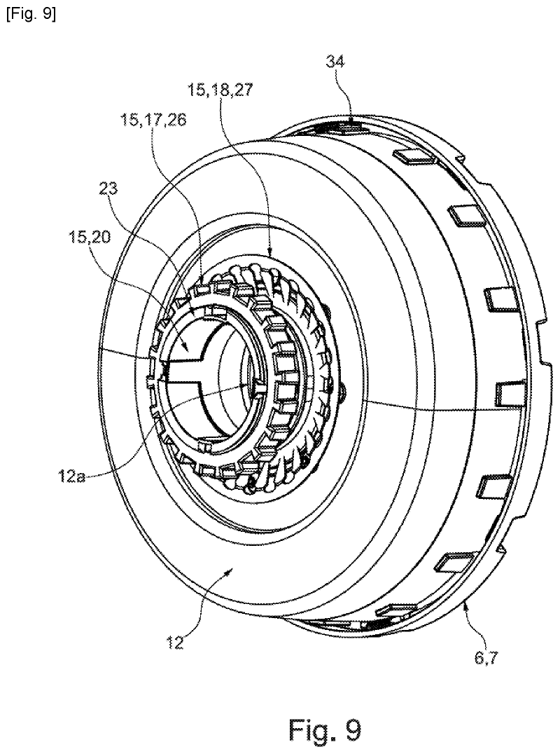

FIG. 9 shows the adjustment device 17 and the intermediate partition 12—disk 7 subassembly without the door 3. The disk 7 and the intermediate partition 12 are secured to each other by the assembly components 34. It can be seen that the sleeve 20 passes through the opening 12a in the intermediate partition 12, with the external protruding end 23 protruding from the intermediate partition 12. The adjustment member 17 in the form of the adjustment nut 26 and the spring member 18 in the form of the spring washer 27 are located outside the intermediate partition 12.

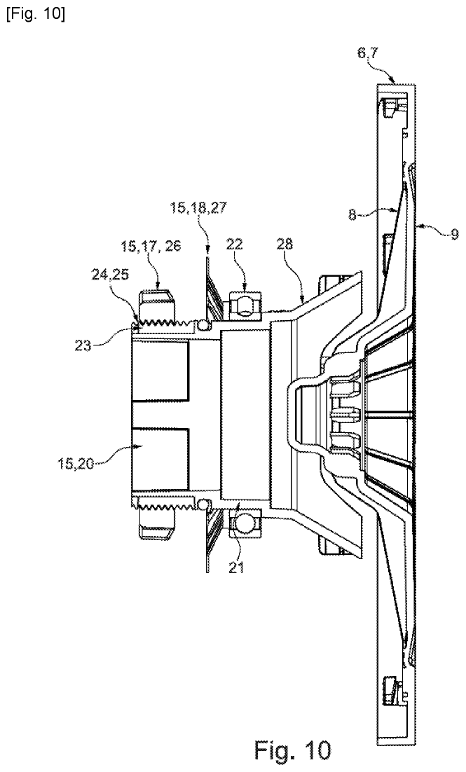

FIG. 10 shows the adjustment device 15 and the disk 7. The sleeve 20 and the disk 7 are aligned axially. The sleeve 20 is generally cylindrical in shape. The sleeve 20 includes the inner portion 21 surrounded by the protruding outer end 23 and the inner end 28. The inner end 28 of the sleeve 20 has a conical flared shape. The inner end 28 of the sleeve 20 faces the upper surface 8 of the disk 7. The protruding outer end 23 includes, on its outer wall 24, the thread 25 onto which the adjustment nut 26 is screwed. The bearing 22 is mounted integrally around the inner portion 21 of the sleeve 20. The bearing 22 supports the spring member 18 in the form of the spring washer 27, which is on the side of the protruding outer end 23.

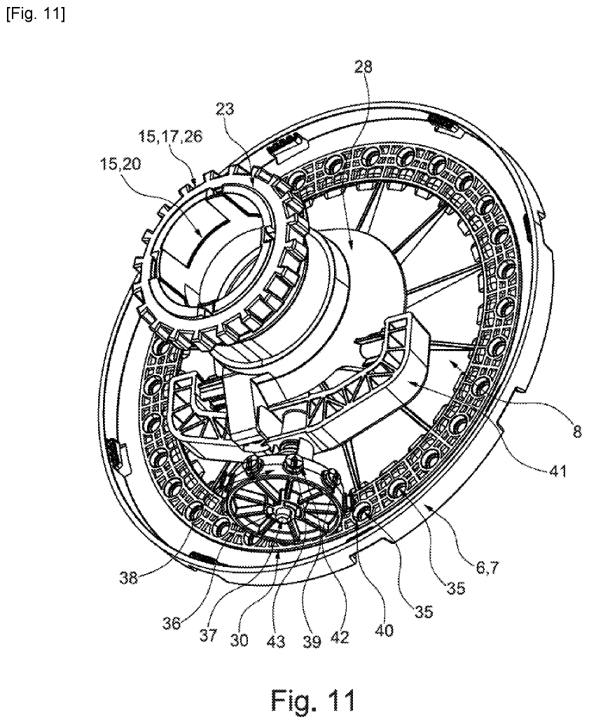

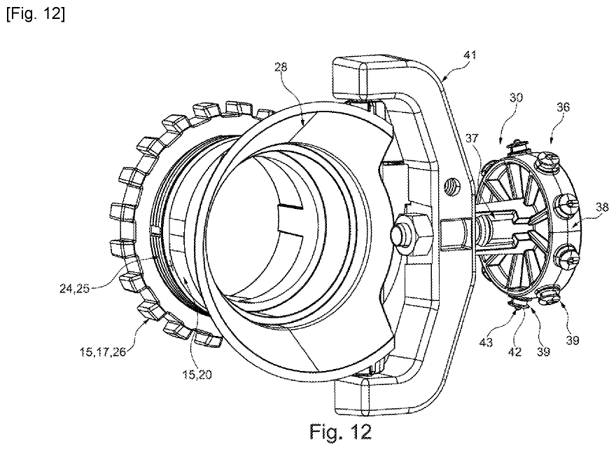

FIGS. 11 and 12 show the adjustment device 17 described above, the disk 7, and the ejection device 30. The ejection device 30 includes the separation wheel 36, which rotates around the rotation axis 37. The separation wheel 36 has a plurality of radial projections 39 protruding from the peripheral surface 38, each of the radial projections 39 being configured to insert into one of the perforations 35 in an insertion position. The radial projections 39 are configured to insert through the entrance 40 of one of the perforations 35 in a sealed manner inside the latter by a form fit and/or by a sealing element in the insertion position so as to achieve sealing inside the perforation 35. The separation wheel 36 is mounted to rotate around the axis of rotation 37 on a support 41 which is fixed to the inner end 28. Each radial projection 39 has an apex 42 from which the centering pin 43 protrudes. This centering pin 43 opens towards the exit (not visible) of the perforation 35 in the insertion position.

The invention also relates to a seed drill (not shown) including a distribution assembly wherein the distribution assembly is in accordance with the invention.

The invention is of course not limited to the embodiments described and shown in the accompanying drawings. Modifications remain possible, particularly with regard to the composition of the various elements or by substituting technical equivalents, without departing from the scope of protection of the invention.

1. A distribution assembly for a seed drill comprising:
a sealed housing including a fixed part and a door that can move between an open position and a closed position,
a drive shaft of a motor opening onto the fixed part,
a distribution member for a plurality of granular elements arranged to distribute a plurality of granular elements in a discrete and singular manner in the form of a perforated disk having a first surface facing the interior of the door in the closed position and a second surface facing the fixed part in the closed position, the disk being mounted around the motor drive shaft to be driven in rotation at least in the closed position and being disposed inside the housing to separate the interior of the housing into a first chamber and a second chamber, which are distinct, the first chamber being configured to receive all or part of the plurality of granular elements and the second chamber being closed by the door,
the second chamber includes a bell-shaped intermediate partition including a circular bearing surface bearing on a peripheral edge of the first surface of the disk,
a device for adjusting a clearance corresponding to the distance between the second surface of the disk and the fixed part of the housing in the closed position,
wherein:
the clearance adjustment device is configured to allow translational movement, in an axial direction parallel to the drive shaft, of the intermediate partition-disk subassembly relative to the fixed part of the housing and to constrain the position of the intermediate partition-disk subassembly relative to the fixed part,
the adjustment device includes an adjustment member for the clearance protruding from the outer face of the door, and configured to adjust the clearance.

2. The distribution assembly according to claim 1, wherein the adjustment device includes a spring member located inside the second chamber between the inner face of the door and the upper outer surface of the intermediate partition.

3. The distribution assembly according to claim 2, wherein the door includes a central passage and the adjustment device includes a sleeve passing through the central passage, mounted so as to slide in the direction of axial translation in the central passage and including an internal portion located in the second chamber including a bearing around which the intermediate partition is mounted integrally, and in that the inner face of the door bears against the spring member and the spring member bears against the bearing so as to exert a bearing force to constrain the intermediate partition-disk subassembly.

4. The distribution assembly according to claim 3, wherein the sleeve includes a protruding outer end of the outer face of the door, the protruding outer end including an outer wall with a thread, and the adjustment member includes an adjustment nut associated with the thread.

5. The distribution assembly according to claim 3, wherein the spring member includes a spring washer positioned around the inner portion of the sleeve and bearing on the bearing.

6. The distribution assembly according to claim 3, wherein the sleeve includes an inner end located in the space between the intermediate partition and the disk, and the distribution assembly includes an ejection device fixed to or near the inner end.

7. The distribution assembly according to claim 1, wherein the distribution assembly includes a cover covering the adjustment member, and the cover is secured by a fastener to the door.

8. The distribution assembly according to claim 1, wherein the outer face of the door includes a visual indicator representing the adjustment of the clearance arranged around the adjustment member.

9. The distribution assembly according to claim 1, wherein the intermediate partition and the disk are secured together by assembly components.

10. A seed drill including a distribution assembly wherein the distribution assembly is in accordance with claim 1.
